(19) United States
(12) Patent Application Publication
(10) Pub. No.: US 2021/0312518 A1
(43) Pub. Date: Oct. 7, 2021

(54) METHOD AND SYSTEM FOR CREATING AND MANAGING FRAGRANCE-RELATED USER PROFILES

(71) Applicant: SMP GMBH, München (DE)

(72) Inventors: Roman BUZNYKOVATYY, München (DE); Guilherme Petterle Silveira MUSSI, Gräfelfing (DE)

(73) Assignee: SMP GMBH, München (DE)

(21) Appl. No.: 17/267,265

(22) PCT Filed: Jul. 15, 2019
(86) PCT No.: PCT/EP2019/069022

§ 371 Date: Feb. 9, 2021

(30) Foreign Application Priority Data
Aug. 14, 2018 (DE) 10 2018 213 683.1

(51) Int. Cl. G06Q 30/06; G06N 3/02; C11B 9/00; A61K 8/04

(52) U.S. Cl. CPC G06Q 30/0625; G06Q 30/0621; A61K 8/046; C11B 9/00; G06N 3/02

(57) ABSTRACT

The present invention relates to a method for creating and managing fragrance-related user profiles, comprising the following steps: —Identifying an initial fragrance preferences profile based on input by a user to be profiled (S2-S5); —Providing the user with a first number of aromatic accords based on the initial fragrance preference profile, wherein the fragrances are provided in fragrance cartridges adapted to be used with an automated fragrance dispenser unit (12) (S6); —Creating a user profile based on the initial fragrance preferences profile and an evaluation of use patterns in accordance with the operation of the automated fragrance dispenser unit (12) (S8); and —Periodically providing the user with replacement fragrance cartridges based on the user profile and updating the user profile based on evaluations of use patterns of the automated fragrance dispenser unit (12) (S10, S8).

The present invention relates to a method for creating and managing fragrance-related user profiles as well as a system for performing such a method.

It has long been known to dispense aromatic liquids such as perfumes or air refresher liquids in the context of cosmetics and other lifestyle fields. For this purpose, manually operated dispensers and diffusers for aromatic liquids are known, with which a user can spray or atomize the liquids upon manual actuation. Additionally, there are electrically operated scent diffusers on the market which atomize aromatic liquids, for example at regular intervals.

The aromatic liquids to be dispensed are usually complex mixtures of up to dozens or hundreds of aromatic molecules dissolved in carrier or solvent liquids which are mixed in predetermined ratios in order to construct so-called “accords”, a reference to music theory where overlaying multiple tonal frequencies with predetermined ratios can lead to different sensations of harmony or tension. Based on the concept of said accords, perfume makers classify the perfumes according to family, sub-family, classifier dimensions, wherein the most intense olfactory sensations are identified as the family, less intense ones are identified as sub-families and the weakest are identified as classifier dimensions. In the field of perfume composition, said accords are themselves comprised of a number of aromatic molecules and usually categorized according to their real-life origin or archetype, namely into categories such as citric, leathery, woody, etc.

It is apparent that due to the huge number of aromatic liquids found in nature and also commercially available to perfume makers, a practically infinite number of possibilities for combining said aromatic liquids is conceivable. Even though this has led to an ever increasing number of perfumes and air refreshers with distinct scents on the market, there is still a demand for personalization of scents. This has for example led to perfume makers offering bespoke scents tailored to their clients who are willing to pay five digit numbers to have their own personalized perfume created. However, all of the scents and perfumes currently on the market are static in such that the mixture ratios of the individual aromatic molecules are fixed by a perfume maker and cannot be dynamically altered and adjusted according to the real-time preferences of the user. Since the personal taste and the olfactory sense of humans tend to change and modulate over time, the static nature of all available perfumes and air refreshers cannot guarantee satisfactory results for any user at any time.

It is therefore the object of the present invention to provide a method for creating and managing fragrance-related user profiles with which the time-dependent changes of the taste and preferences of users can be accounted for and with which predictions can be made based on which at any time a satisfactory scent can be provided to a user based on the evaluation of available data. For this purpose, the method according to the invention comprises the following steps:
Identifying an initial fragrance preference profile based on input by a user to be profiled,
Providing the user with a first number of aromatic accords based on the initial fragrance profile, wherein the fragrances are provided in fragrance cartridges adapted to be used with an automated fragrance dispenser unit,
Creating a user profile based on the initial fragrance preference profile and an evaluation of use patterns in accordance with the operation of the automated fragrance dispenser unit, and
Periodically providing the user with replacement fragrance cartridges based on the user profile and updating the user profile based on evaluations of use patterns of the automated fragrance dispenser unit.

Thus, with the method according to the invention, by monitoring the use pattern of a user and providing him or her with replacement fragrance cartridges periodically and at least partially based on said use patterns, a feedback loop is created, in which data is constantly produced and employed for updating and specifying the ever changing taste and preferences of the corresponding user. Thus, the automated fragrance dispenser unit not only serves as the hardware actually providing the fragrance to the user but also as the interface between the user and the underlying algorithms for tracking and predicting his/her preferences. In adjusting the operation of the dispenser unit as well as the provision of new fragrances at least partially based on the descriptions made from the user profile and evaluating the user's reaction on said adjustments, the feedback loop is closed and an ever increasing predictive power of the method according to the invention is expected based on the principles of machine learning.

In order to identify the initial fragrance preferences profile, several strategies are possible. In a most basic embodiment of the present invention, a user could simply choose from a limited number of predefined initial fragrance preferences profiles, for example based on suggestions or verbal descriptions of preferred scents.

In a more sophisticated embodiment, the identifying of the initial fragrance preferences profile may comprise providing the user with a second number of fragrances, the second number of fragrances being larger than the first number of aromatic accords, for identifying olfactory preferences and/or perception thresholds. Based on the fragrances provided for the identifying of the initial fragrance preferences profile, the user may enter his or her specific preferences and thresholds into a dedicated website, smartphone application or similar and based on his or her input, possibly together with additional input such as gender, age, location and other demographical and/or behavioral segmentation parameters, the initial fragrance preferences profile may be identified based on suitable algorithms and/or neural networks.

For the creation of the user profile and the updating of said profile, use patterns of an operation of the automatic fragrance dispenser unit are evaluated. For this purpose, the operation of the automated fragrance dispenser unit may be based on input by the user and/or adjusted based on the user profile. At this point, the user interacts with the underlying system performing the method according to the invention and provides his or her input to the feedback loop on which his or her profile is created and updated. Possible parameters of the operation of the dispenser unit which could be evaluated in this context of course depend on the actual hardware and its possibilities and implemented operation modes and may include modes and times of operation, types and ratios of dispensed scents out of the first number of aromatic accords and so on.

While the providing of replacement fragrance cartridges may be performed based on a strictly periodic timetable, such as a monthly delivery, the period for providing the user with displacement fragrance cartridges may also be adjusted based on the operation history of the automated fragrance dispenser unit and on the user profile. The data collected in the above-described feedback loop may thus not only be used for creating and updating the user profile, but also for monitoring the operation of the automated fragrance dispenser unit concerning the amount of fragrance dispensed and therefore the need for replacing empty fragrance cartridges. The evaluation may of course also be performed based on the user profile, since the profile can contain information on how frequently the user operates the automated fragrance dispenser unit, from which information the period for replacing the cartridges can be derived.

If a single user has access to at least two automated fragrance dispenser units, the use patterns of multiple or all of said automated fragrance dispenser units can be evaluated for updating a single user profile. Retrieving data from multiple automated fragrance dispenser units can increase the granularity and level of detail of the user profile such that it can be evaluated under which circumstances and in which surroundings the user prefers a certain scent, for example a user may prefer different scents in his/her apartment, office and his/her car. Based on said data, even more precise predictions can be made about the present and future preferences of the user.

Furthermore, the identification of the initial fragrance preferences profile and the updating of the user profile may additionally be performed based on the user profile of at least one additional user. For example, users of a similar age group and in similar geographic areas may have an overlap in taste concerning scents which may be reflected in their user profiles and which can be employed for the generation of future initial fragrance preference profiles profile and the updating of current user profiles.

In a similar manner, the evaluation of use patterns may comprise an identification of use cycles, for example daily, weekly and/or yearly use cycles. By evaluating such patterns, it can be accounted for the fact that many users prefer different scents in different seasons or at different times of the day, such that precise predictions can be made about re-occurring preferences in the future.

Furthermore, the user profile can additionally be updated based on physiological and/or psychological variables of the user or any external input. For this purpose, any available data on the user can beneficially be used as long as the user agrees with the use of his or her data for this purpose. For example, any activities performed on social network channels or recorded by tracking devices or mobile phones may indicate towards changing preferences concerning scents. Furthermore, external input such as weather data may be processed and used for updating user profiles.

Due to the enormous amount of data available and usable for the method according to the present invention, the evaluation of use patterns and updating on the user profile, possibly also based on any additional available data, may be performed using a neural network. Such neural networks have shown to be specially suited for such purposes, since their native feature of improving predictions over time by learning through feedback makes them an optimal choice for such tasks.

While the fragrances used in the automated fragrance dispenser unit and, if applicable, also for identifying the initial fragrance preferences profile may be isolated aromatic molecules, in a preferred embodiment they are scent accords comprising multiple aromatic compounds. Said scent accords are readily available and preassembled by expert perfume makers, such that the user is not tasked with the low-level composition of suitable accords but can concentrate on the high-level task of combining said prefabricated accords according to his or her preferences during the operation of the automated fragrance dispenser unit.

For this purpose, the automated fragrance dispenser unit may be arranged to dispense multiple fragrances concurrently with controlled mass flow ratios between them, preferably at least five fragrances. Said mass flow rates may be controlled by the user of the dispenser unit to any desired level of detail, for examples with only a few presets or down to the percent level, depending on the employed hardware and software.

In a more basic embodiment, a single fragrance may be dispensed, wherein the operation of the automated fragrance dispenser unit may also be evaluated when only one fragrance is available to the dispenser unit. However, this will lead to a less sophisticated data analysis and profile updating.

In order to avoid “olfactory fatigue”, which is due to the human olfactory sense tending to get accustomed to scents rather quickly, the mass flow ratios according to which the fragrances are concurrently dispensed by the automated fragrance dispenser unit may be time-modulated in a predetermined or random manner within predefined boundaries. By time-modulating the composition of the overall scent dispensed by the automated fragrance dispenser unit, depending on the predefined boundaries, the “tonality” of the resulting overall scent may be preserved or altered to a desired degree, while the total intensity of the scent may also be altered to a degree which is perceivable by the user or not, depending on the desired mode of operation.

In a preferred embodiment of the method according to the invention, the first number of aromatic accords can be at least five and the second number of fragrances can be at least ten, preferably at least twenty, most preferably at least thirty. By providing such a large number of fragrances both for identifying the initial fragrance preferences profile and for updating the user profile, the granularity as well as the responsiveness of the changes of the user profile may both be high. For performing the identification of the initial fragrance preferences, a dedicated device may be used or the user may be provided with a number of samples which could either be used in the automated fragrance dispenser unit or simply manually sampled by the user. The more fragrances are provided however, the more convenient the integration of another device may become.

According to a second aspect, the present invention relates to a system for performing the method according to the invention, comprising an automated fragrance dispenser unit and a back end server in data communication. All computing and data analysis tasks may be split up between the control unit of the automated fragrance dispenser unit and the back end server such that the automated fragrance dispenser unit may perform some preliminary or sophisticated data analyses itself or it may simply forward the use pattern related data to the back end server where all of the calculations are subsequently performed and the user profile is stored.

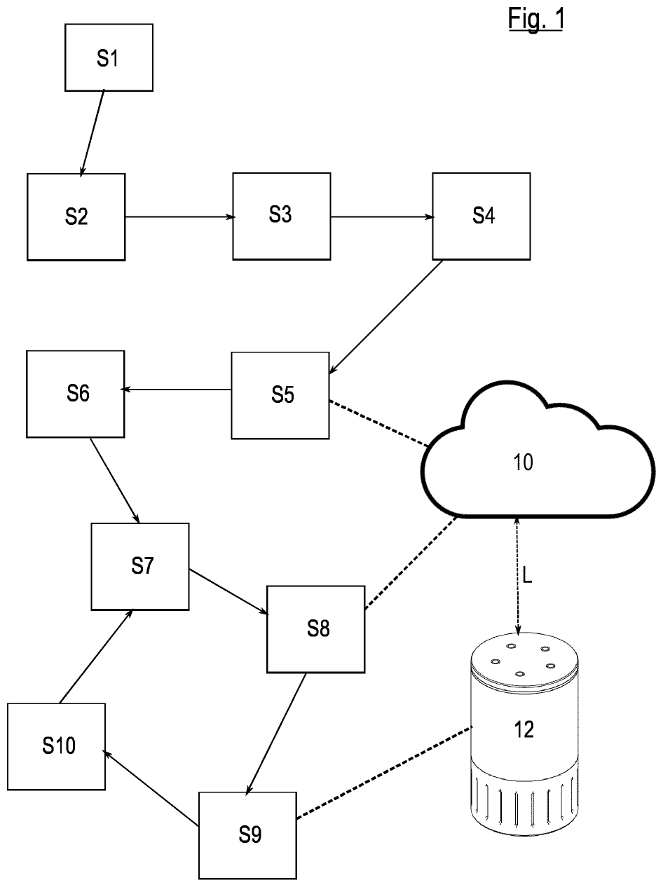

Additional features and advantages of the present invention will become even clearer from the following description of an embodiment when considered together with the accompanying FIG. 1. Said FIG. 1 shows a flowchart and a schematic view of an embodiment of the method and system according to the present invention.

Referring to the flowchart of FIG. 1, according to the present invention, a potential user of the method first orders a so-called “scent master kit” at step S1. He or she may already enter data into a web form or a smartphone application before having received said kit, for example answering questions on his/her scent preferences by selecting one out of multiple pre-defined initial fragrance preferences profiles or other personal data which may be usable for the identifying of an initial fragrance preferences profile (step S2).

After the scent master kit, which may contain about 30 representative samples of scent accords, has been shipped to the user at step S3, he/she may at step S4 sample the different scents at home and enter more data concerning preferences and perception thresholds into the above-mentioned web form or smartphone application.

From the data received at steps S2 and S4, at step S5, a back end server 10 employing sophisticated data analysis techniques such as neural networks or other dedicated and tuned algorithms and possibly also taking into account additional data, such as profiles of other users with similar preferences and/or personalities, will identify the user's initial fragrance preferences profile.

Based on said initial fragrance preferences profile, at step S6, a number of fragrance cartridges are shipped to the user, which are foreseen to be used in the automated fragrance dispenser unit 12. The actual number of cartridges to be shipped may vary depending on the type of automated fragrance dispenser unit and the user's choice, however typically about five such cartridges will be employed in the automated fragrance dispenser unit 12.

At step S7, in order to kick off the feedback loop according to the invention, the user starts and adjusts the operation of the automated fragrance dispenser unit 12 according to his/her preferences with the fragrances provided in step S6. The automated fragrance dispenser unit 12 and connected smartphone application constantly monitor the use patterns controlled by the user and forwards data related to said use patterns to the back end server 10 via a data link L.

At the first occurrence of step S8, the back end server 10 recognizes the use patterns of the operation of the automated fragrance dispenser unit 12 and based on an evaluation thereof together with the initial fragrance preferences profile, creates a user profile. Said user profile is forwarded to the automated fragrance dispenser unit 12 and smartphone application again via the data link L, such that in step S9, the automated fragrance dispenser unit 12 can adjust its operation based on the derived user profile and predictions about user preferences in real-time.

Said predictions may include start and stop times of the operation, mass flow ratios of scent accords to be dispensed etc. The feedback loop closes in step S10 where periodically new fragrance cartridges are delivered to the user, either simply replacing empty ones or different ones, based on user feedback such as manual adjustments of the operation parameters of the automated fragrance dispenser unit 12.

When in step S7, the user again starts and adjusts the operation of the automated fragrance dispenser unit 12 with the replaced cartridges, his/her user profile is still stored in the backend server such that in step S8, no new profile needs to be created, but rather the existing profile will be updated, again based on user feedback such as manual adjustments of the operation parameters of the automated fragrance dispenser unit 12. It has to be noted that such an update can be performed at any time of the operation of the automated fragrance dispenser unit 12 and not only after the delivery of new cartridges, for example at fixed time intervals or after each manual adjustment of the operation parameters of the dispenser unit 12 and smartphone application by the user.

Concerning the design and layout of the back end server 10 and the automated fragrance dispenser unit 12, various embodiments can be used as long as the basic functionality needed for the method according to the invention is provided. For this purpose, the back end server 10 requires sufficient computing power and storage as well as a high-throughput network connection in order to handle incoming and outgoing data streams and computing tasks as well as to store the user profiles. The automated dispenser unit 12 on the other hand has to be capable of some sort of interaction with its user in order to control its operation, preferably via a bluetooth link to a mobile phone or an integrated control panel. Furthermore, it needs to have sufficient computing power and storage to record the user's use patterns and needs to be in data connection with the back end server 12 in order to provide said data to the server and receive the created and updated user profile back regularly.

1. Method for creating and managing fragrance-related user profiles, comprising the following steps:
Identifying an initial fragrance preferences profile based on input by a user to be profiled;
Providing the user with a first number of aromatic accords based on the initial fragrance preference profile, wherein the fragrances are provided in fragrance cartridges adapted to be used with an automated fragrance dispenser unit;
Creating a user profile based on the initial fragrance preferences profile and an evaluation of use patterns in accordance with the operation of the automated fragrance dispenser unit; and
Periodically providing the user with replacement fragrance cartridges based on the user profile and updating the user profile based on evaluations of use patterns of the automated fragrance dispenser unit.

2. Method according to claim 1, wherein the identifying of the initial fragrance preferences profile comprises providing the user with a second number of fragrances, the second number of fragrances being larger than the first number of aromatic accords, for identifying olfactory preferences and/or perception thresholds.

3. Method according to claim 1, wherein the identifying of the initial fragrance preferences profile comprises a selection of one out of multiple pre-defined initial fragrance preferences profiles.

4. Method according to claim 1, wherein the operation of the automated fragrance dispenser unit is based on input by the user and/or adjusted based on the user profile.

5. Method according to claim 1, wherein the period for providing the user with replacement fragrance cartridges is adjusted based on the operational history of the automated fragrance dispenser unit and/or the user profile.

6. Method according to claim 1, wherein the use patterns of multiple automated fragrance dispenser units can be evaluated for updating a single user profile.

7. Method according to claim 1, wherein the identification of the initial fragrance preferences profile and the updating of the user profiles are additionally performed based on the user profile of at least one additional user.

8. Method according to claim 1, wherein the evaluation of use patterns comprises an identification of use cycles.

9. Method according to claim 1, wherein the user profile is additionally updated based on physiological and/or psychological variables of the user.

10. Method according to claim 1, wherein the evaluation of use patterns and updating of the user profile is performed using a neural network.

11. Method according to claim 1, wherein the fragrances are scent accords comprising multiple aromatic accords.

12. Method according to claim 1, wherein the automated fragrance dispenser unit is arranged to dispense multiple fragrances concurrently with controlled mass flow ratios between them.

13. Method according to claim 12, wherein the mass flow ratios according to which the fragrances are concurrently dispensed are time-modulated in a pre-determined of random manner within pre-defined boundaries.

14. Method according to claim 1, wherein the first number of aromatic accords is at least five and the second number of fragrances is at least 10.

15. System for performing a method according claim 1, comprising an automated dispenser unit and a backend server in data communication.
